(19) United States
(12) Patent Application Publication
(10) Pub. No.: US 2014/0187700 A1
(43) Pub. Date: Jul. 3, 2014

(54) Polyester Resin Composition for Reflectors of Light Emitting Devices and Molded Article Using Same

(71) Applicant: Cheil Industries Inc., Gumi-si (KR)

(72) Inventors: Sang Hwa Lee, Uiwang-si (KR); Hyun Ho Lee, Uiwang-si (KR); In Geol Baek, Uiwang-si (KR); Sang Hyun Hong, Uiwang-si (KR); Jong Cheol Lim, Uiwang-si (KR)

(73) Assignee: Cheil Industries Inc., Gumi-si (KR)

(21) Appl. No.: 14/102,535

(22) Filed: Dec. 11, 2013

(30) Foreign Application Priority Data
Dec. 31, 2012 (KR) 10-2012-0157863

(51) Int. Cl. C08L 67/02

(52) U.S. Cl. CPC C08L 67/02
USPC 524/396

(57) ABSTRACT

A polyester resin composition includes: (A) a polyester resin having a crystallization temperature of about 200° C. to about 400° C.; (B) a polyester resin having a crystallization temperature of about 100° C. to less than about 200° C.; (C) a white pigment; (D) a filler; (E) a nucleating agent; and (F) a chain extender. The polyester resin composition can have superior heat resistance, impact resistance, cooling efficiency, reflectivity, yellowing resistance, and/or fluidity. The polyester resin composition is suitable for reflectors of light emitting devices.

### CROSS-REFERENCE TO RELATED APPLICATION

This application claims priority under 35 USC Section 119 to and the benefit of Korean Patent Application No. 10-2012-0157863, filed Dec. 31, 2012, the entire disclosure of which is incorporated herein by reference.

### FIELD OF THE INVENTION

The present invention relates to a polyester resin composition and a molded article using same. More particularly, the present invention relates to a polyester resin composition that can have superior heat resistance, impact resistance, cooling efficiency, reflectivity, yellowing resistance, and/or fluidity, which can be suitable for reflectors of light emitting devices, and a molded article made using same.

### BACKGROUND OF THE INVENTION

Recently, polyester-based resins have been used in the manufacture of parts for light emitting diodes (hereinafter “LEDs”). LEDs are rapidly replacing existing light sources due to their outstanding energy efficiency and long lifespan. Polyester-based resins can be used for reflectors, reflector cups, scramblers, housings, and the like, which are parts of LEDs.

An LED generally includes a semiconductor part emitting light, an electric wire, a reflector as a housing, and a transparent encapsulant encapsulating the semiconductor part. The reflector can be made of a ceramic or heat resistant plastic. However, ceramics do not provide good productivity, and heat resistant plastics can result in reduced optical reflectivity due to changes in color during an injection molding operation, or when the encapsulant is thermally cured, or when the LED is used under actual environmental conditions.

Conventionally, polyphthalamide (PPA), a type of high heat resistant nylon resin, has been used in reflectors of LEDs. However, the high heat resistant nylon resin significantly deteriorated after being used for a long period of time, and the color thereof can become irregular, thereby reducing the performance of products including the same.

In order to overcome the above-mentioned problem of the PPA resin, a high heat resistant modified polyester resin can be used instead of the PPA resin. The high heat resistant modified polyester resin is a polyester-based resin having a benzene ring in its main chain, reinforced using a reinforcing material such as glass fiber. However, when the high heat resistant modified polyester resin is used as an LED reflector, a yellowing phenomenon occurs due to the constant irradiation with a light source. The yellowing causes a reduction of whiteness.

In addition, there is a need to improve impact strength in order to prevent cracking, which can occur during an LED package fabricating process, particularly as the thickness of LEDs decreases. Electrically non-conductive properties are required as well.

### SUMMARY OF THE INVENTION

The present invention provides a novel polyester resin composition which can be used in the manufacture of reflectors of light emitting devices (LEDs), as well as other devices emitting light such as various kinds of electronic parts, indoor lamps, outdoor lamps, vehicle lamps, display devices, and head lights.

The present invention also provides a polyester resin composition that can have superior heat resistance, impact resistance, cooling efficiency, reflectivity, yellowing resistance, and/or fluidity so that it can be used as reflectors for various kinds of light emitting devices.

The present invention further provides a molded article made using the polyester resin composition.

The polyester resin composition in accordance with the present invention comprises (A) a polyester resin having a crystallization temperature of about 200° C. to about 400° C., (B) a polyester resin having a crystallization temperature of about 100° C. to less than about 200° C., wherein the polyester resin (B) is not the same as polyester resin (A) and has a different crystallization temperature than polyester resin (A), (C) a white pigment, (D) a filler, (E) a nucleating agent, and (F) a chain extender.

The polyester resin composition of the present invention can comprise about 0.1 to about 80 parts by weight of the white pigment (C); about 0.1 to about 80 parts by weight of the filler (D); about 0.01 to about 10 parts by weight of the nucleating agent (E); and about 0.01 to about 10 parts by weight of the chain extender (F), each based on about 100 parts by weight of a base resin comprising about 10 to about 90% by weight of the polyester resin (A) having a crystallization temperature of about 200° C. to about 400° C. and about 10 to about 90% by weight of the polyester resin (B) having a crystallization temperature of about 100° C. to less than about 200° C.

The polyester resin (A) can be prepared by condensation polymerization of an aromatic dicarboxylic acid component and a diol component including an alicyclic diol.

The polyester resin (A) can include a poly(cyclohexane-1,4-dimethylene terephthalate) (PCT)-based resin including a repeating unit represented by Chemical Formula 1 below:

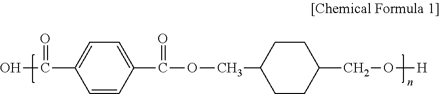

wherein, in Chemical Formula 1, n is an integer of 50 to 500.

The polyester resin (B) can include a poly(trimethylene terephthalate) (PTT)-based resin including a repeating unit represented by Chemical Formula 2 below:

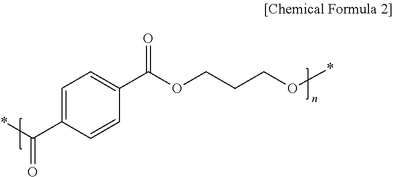

wherein, in Chemical Formula 2, n is an integer of 50 to 500.

The polyester resin (A) may comprise about 15 to about 100 mole % of 1,4-cyclohexane dimethanol and 0 to about 85 mole % of ethylene glycol based on 100 mole % of the entire diol component.

The polyester resin (B) may further comprise a homopolymer and/or a copolymer of an alkylene terephthalate which has a different structure from the repeating unit structure of Chemical Formula 2. The homopolymer and/or the copolymer of the alkylene terephthalate can include a homopolymer and/or a copolymer of a C₂ to C₈ alkylene terephthalate which has a different structure from the repeating unit structure of Chemical Formula 2.

The homopolymer and/or the copolymer of alkylene terephthalate can include a homopolymer and/or a copolymer of butylene terephthalate, a homopolymer and/or a copolymer of ethylene terephthalate, and/or a homopolymer and/or a copolymer of hexamethylene terephthalate.

The white pigment (C) can comprise titanium oxide, zinc oxide, zinc sulfide, white lead, zinc sulfate, barium sulfate, calcium carbonate, aluminum oxide, or a combination thereof. The white pigment (C) can be titanium dioxide and can have an average particle diameter of about 0.05 to about 2.0 μm.

The filler (D) can comprise carbon fiber, glass fiber, boron fiber, glass bead, glass flake, carbon black, clay, kaolin, talc, mica, calcium carbonate, wollastonite, potassium titanate whisker, aluminum borate whisker, zinc oxide whisker, calcium whisker, or a combination thereof. The filler (D) can include glass fiber, which can have an average length of about 0.1 to about 20 mm and an aspect ratio of about 10 to about 2,000.

The nucleating agent (E) can include disodium phthalate represented by below Chemical Formula 3.

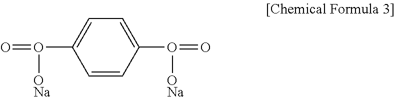

The chain extender (F) can include a compound in which an end group of bisphenol-A is substituted by an epoxy group, wherein the bisphenol-A can be represented by below Chemical Formula 4.

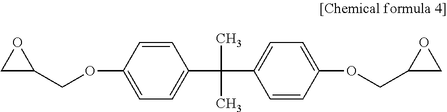 [SMILES: CC(C)(c1ccc(OCC2CO2)cc1)c1ccc(OCC2CO2)cc1]

The nucleating agent (E) and the chain extender (F) can be included at a weight ratio of about 1:10 to about 10:1.

A molded article prepared by the polyester resin composition of the present invention can be a reflector of a light emitting device including an LED reflector.

The present invention can provide a polyester resin composition having heat resistance, impact resistance, cooling efficiency, reflectivity, yellowing resistance, and/or fluidity and a molded article using same. The polyester resin composition can be used in a reflector of a light emitting device that emits light, and also in various kinds of electronic parts, indoor lamps, outdoor lamps, vehicle lamps, display devices, and head lights in addition to LEDs.

### DETAILED DESCRIPTION OF THE INVENTION

The present invention now will be described more fully hereinafter in the following detailed description of the invention in which some but not all embodiments of the invention are described. Indeed, this invention may be embodied in many different forms and should not be construed as limited to the embodiments set forth herein; rather, these embodiments are provided so that this disclosure will satisfy applicable legal requirements.

The present invention relates to a polyester resin composition that can have heat resistance, impact resistance, cooling efficiency, reflectivity, yellowing resistance, and/or fluidity, and can be suitable for use in the manufacture of reflectors for various kinds of light emitting devices.

The polyester resin composition of the present invention can maintain the impact strength of polyester resin compositions even at high temperatures by including two polyester resins having different crystallization temperatures as a base resin along with a white pigment, a filler, a nucleating agent, and a chain extender.

The polyester resin composition of the present invention comprises (A) a polyester resin having a crystallization temperature about 200° C. to about 400° C., (B) a polyester resin having a crystallization temperature about 100° C. to less than about 200° C., wherein the polyester resin (B) is not the same as polyester resin (A) and has a different crystallization temperature than polyester resin (A), (C) a white pigment, (D) a filler, (E) a nucleating agent, and (F) a chain extender.

The polyester resin composition of the present invention can comprise about 0.1 to about 80 parts by weight of the white pigment (C); about 0.1 to about 80 parts by weight of the filler (D); about 0.01 to about 10 parts by weight of the nucleating agent (E); and about 0.01 to about 10 parts by weight of the chain extender (F), each based on about 100 parts by weight of a base resin comprising about 10 to about 90% by weight of the polyester resin (A) having a crystallization temperature about 200° C. to about 400° C. and about 10 to about 90% by weight of the polyester resin (B) having a crystallization temperature about 100° C. to less than about 200° C.

Hereinafter, each of components will be described in detail.

(a) Polyester Resin Having a Crystallization Temperature of about 200° C. To about 400° C.

A polyester resin used for the present invention has superior heat resistance in order to be used as engineering plastics, especially reflectors of light emitting devices. In order to have superior heat resistance, the polymer has a high melting point by including a ring-shaped structure. However, an excessively high melting point reduces processibility. Thus, the polyester resin (A) has a melting point of about 200° C. or more, for example about 200° C. to about 400° C., and as another example about 220 to about 320° C.

Polyester resins used for engineering plastics are mostly aromatic polyester resins. A dicarboxylic acid component of the aromatic polyester resin (A) can include an aromatic dicarboxylic acid and/or a derivative thereof. Examples thereof can include without limitation terephthalic acid, isophthalic acid, phthalic acid, naphthalene dicarboxylic acid, and the like, and combinations thereof. In exemplary embodiments, terephthalic acid can be used.

In order to form a ring-shaped repeating unit as a diol component for the polyester resin (A) of the present invention, an alicyclic diol, such as but not limited to 1,4-cyclohexane dimethanol (CHDM), can be used. In order to obtain the superior heat resistance of a molded article using the polyester resin composition of the present invention, the polyester resin (A) can be a poly(cyclohexane-1,4-dimethylene terephthalate) (PCT)-based resin including a repeating unit represented by below Chemical Formula 1 prepared by the condensation polymerization of terephthalic acid and 1,4-cyclohexane dimethanol.

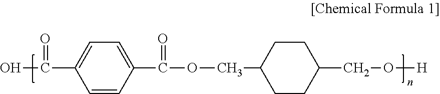

In Chemical Formula 1, n is an integer of 50 to 500.

The diol component of the polyester resin (A) can further comprise an aliphatic glycol, such as ethylene glycol (EG), in addition to the alicyclic diol, such as 1,4-cyclohexane dimethanol.

When an aliphatic diol such as ethylene glycol is included, the diol component of the polyester resin (A) can comprise about 15 to about 100 mole % of the alicyclic diol such as 1,4-cyclohexane dimethanol and 0 to about 85 mole % of the aliphatic diol such as ethylene glycol, for example about 30 to about 80 mole % of 1,4-cyclohexane dimethanol and about 20 to about 70 mole % of ethylene glycol, based on 100 mole % of the diol component.

In some embodiments, the diol component of the polyester resin (A) can include an alicyclic diol (such as CHDM) in an amount of about 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 mole %. Further, according to some embodiments of the present invention, the alicyclic diol may be present in an amount of from about any of the foregoing amounts to about any other of the foregoing amounts.

In some embodiments, the diol component of the polyester resin (A) can include an aliphatic diol (such as EG) in an amount of 0 (the aliphatic diol is not present), about 0 (the aliphatic diol is present) 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, or 85 mole %. Further, according to some embodiments of the present invention, the aliphatic diol may be present in an amount of from about any of the foregoing amounts to about any other of the foregoing amounts.

A diol component including ethylene glycol can prevent the heat resistance of polyester resins from being reduced and can improve impact resistance.

The polyester resin (A) can be modified by further including one or more kinds of C₆ to C₂₁ aromatic diols and/or C₃ to C₈ aliphatic diols as the diol component. The amount thereof can be 0 to about 3 mole % based on 100 mole % of the diol component. Examples of the C₆ to C₂₁ aromatic diols and the C₃ to C₈ aliphatic diols may include without limitation propane-1,3-diol, butane-1,4-diol, pentane-1,5-diol, hexane-1,6-diol, 3-methylpentane-2,4-diol, 2-methylpentane-1,4-diol, 2,2,4-trimethylpentane-1,3-diol, 2-ethylhexane-1,3-diol, 2,2-diethylpropane-1,3-diol, 1,4-cyclobutanedimethanol, 2,2-bis-(3-hydroxyethoxyl)enyl)-propane, 2,2-bis-(4-hydroxypropoxyphenyl)-propane, and the like. These can be used alone or a mixture of two or more thereof.

The polyester resin (A) can have an intrinsic viscosity[η] of about 0.4 to about 1.5 dl/g, for example about 0.5 to about 1.1 dl/g, as measured in an o-chlorophenol solution of 25° C. When the intrinsic viscosity[η] is less than about 0.4 dl/g, the mechanical properties of the polyester resin composition can be reduced. When the intrinsic viscosity[η] is more than about 1.5 dl/g, the moldability of the polyester resin composition can be reduced.

The polyester resin (A) of the present invention can be prepared by well-known conventional condensation polymerization, and the condensation polymerization can comprise the direct condensation of acids based on transesterification using glycol or lower alkyl ester.

The base resin including polyester resin (A) having a crystallization temperature of about 200° C. to about 400° C. and the polyester resin (B) having a crystallization temperature of about 100° C. to less than about 200° C. and polyester resin (B) can include the polyester resin (A) in an amount of about 10 to about 90% by weight, based on the total weight (100% by weight) of the base resin. In some embodiments, the base resin can include the polyester resin (A) in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90% by weight. Further, according to some embodiments of the present invention, the polyester resin (A) may be present in an amount of from about any of the foregoing amounts to about any other of the foregoing amounts.

When the amount of the polyester resin (A) is less than about 10% by weight, the crystallization temperature (Tc) and the heat resistance (HDT) of the polyester resin composition can be reduced. When the amount of the polyester resin (A) is more than about 90% by weight, the impact strength of the polyester resin composition at high temperatures can be reduced.

(B) Polyester Resin Having a Crystallization Temperature of about 100° C. to Less than about 200° C.

When only the polyester resin (A) is used, especially a PCT-based resin, the polyester resin composition can exhibit reduced mechanical properties such as reduced impact strength because bonds in the polymer can be broken (hydrolyzed) when the composition is exposed or subjected to high temperatures. Also, when a rubber component is used to maintain impact strength, it affects crystallization temperatures and moldability may be reduced. Thus, the use of a polyester resin (B) having a crystallization temperature of about 100° C. to less than about 200° C. in addition to the polyester resin (A) can maintain the impact strength without reducing the cooling time (crystallization speed) thereof. The polyester resin (B) is not the same as polyester resin (A) and has a different crystallization temperature than polyester resin (A).

Most polyester resins used as engineering plastics are aromatic polyester resins. Thus, the dicarboxylic acid component of the polyester resin (B) can include an aromatic dicarboxylic acid and/or a derivative thereof. Examples thereof include without limitation terephthalic acid, isophthalic acid, phthalic acid, naphthalene dicarboxylic acid, and the like, and combinations thereof. In exemplary embodiments, terephthalic acid can be used.

The diol component of the polyester resin (B) can include 1,3-propane diol. In order to improve the thermal stability of the polyester resin composition at high temperatures, the polyester resin (B) can be a homopolymer and/or a copolymer of trimethylene terephthalate, such as a poly(trimethylene terephthalate) (PTT)-based resin including a repeating unit structure represented by Chemical Formula 2 below, prepared by the condensation polymerization of terephthalic acid and 1,3-propane diol.

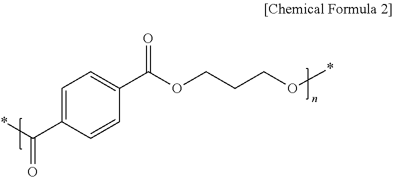

In Chemical Formula 2, n is an integer of 50 to 500.

The PTT-based resin comprising the repeating unit structure of Chemical Formula 2 can comprise trimethylene terephthalate in an amount of about 65 to about 99.9% by weight, for example about 80 to about 99% by weight, and as another example about 85 to about 95% by weight, based on the total weight (100% by weight) of the PTT-based resin. In some embodiments, the PTT-based resin can include trimethylene terephthalate in an amount of about 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.1, 99.2, 99.3, 99.4, 99.5, 99.6, 99.7, 99.8, or 99.9% by weight. Further, according to some embodiments of the present invention, poly(trimethylene terephthalate) may be present in an amount of from about any of the foregoing amounts to about any other of the foregoing amounts.

Examples of the trimethylene terephthalate copolymer can include without limitation trimethylene terephthalate-butylene terephthalate copolymer, trimethylene terephthalate-ethylene terephthalate copolymer, and the like, and combinations thereof.

The polyester resin (B) can be a mixture prepared by mixing a homopolymer and/or a copolymer including a repeating unit structure of the above Chemical Formula 2 and a homopolymer and/or a copolymer of an alkylene terephthalate which has a different structure from the repeating unit structure of Chemical Formula 2. The mixture can include the homopolymer and/or the copolymer of the alkylene terephthalate in an amount of about 65 to about 99.9% by weight, for example about 80 to about 99% by weight, and as another example about 85 to about 95% by weight, based on the total weight (100% by weight) of the entire mixture. In some embodiments, the mixture can include the homopolymer and/or the copolymer of the alkylene terephthalate in an amount of about 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.1, 99.2, 99.3, 99.4, 99.5, 99.6, 99.7, 99.8, or 99.9% by weight. Further, according to some embodiments of the present invention, the homopolymer and/or the copolymer of the alkylene terephthalate may be present in an amount of from about any of the foregoing amounts to about any other of the foregoing amounts.

The homopolymer and/or the copolymer of the alkylene terephthalate which has a different structure from the repeating unit structure of Chemical Formula 2 can include a homopolymer and/or a copolymer of a C₂ to C₈ alkylene terephthalate which is different from the repeating unit structure of Chemical Formula 2, for example a homopolymer and/or a copolymer of a C₂ to C₆ alkylene terephthalate which is different from the repeating unit structure of Chemical Formula 2.

Examples thereof include without limitation a homopolymer and/or a copolymer of butylene terephthalate, a homopolymer and/or a copolymer of ethylene terephthalate, a homopolymer and/or a copolymer of hexamethylene terephthalate, and the like and combinations thereof.

Examples of mixtures of a homopolymer and/or copolymer of an alkylene terephthalate which is different from a homopolymer and/or a copolymer of trimethylene terephthalate can include without limitation a mixture of a homopolymer and/or a copolymer of trimethylene terephthalate and a homopolymer and/or a copolymer of butylene terephthalate; and/or a mixture of a homopolymer and/or a copolymer of trimethylene terephthalate and a homopolymer and/or a copolymer of ethylene terephthalate.

When a mixture of a homopolymer of trimethylene terephthalate and a homopolymer of butylene terephthalate is used, the mixture thereof can include the homopolymer of trimethylene terephthalate in an amount of about 65 to about 99% by weight, for example about 80 to about 98% by weight, and as another example about 85 to about 95% by weight, based on 100% by weight of the mixture of a homopolymer of trimethylene terephthalate and a homopolymer of butylene terephthalate. In some embodiments, the mixture of a homopolymer of trimethylene terephthalate and a homopolymer of butylene terephthalate can include the homopolymer of trimethylene terephthalate in an amount of about 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99% by weight. Further, according to some embodiments of the present invention, the homopolymer of trimethylene terephthalate may be present in an amount of from about any of the foregoing amounts to about any other of the foregoing amounts.

The polyester resin (B) can include poly(trimethylene terephthalate) in an amount of about 54 to about 98% by weight, for example about 59 to about 96% by weight, and as another example about 64 to about 94% by weight, based on 100% by weight of the polyester resin (B). In some embodiments, the polyester resin (B) can include poly(trimethylene terephthalate) in an amount of about 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, or 98% by weight. Further, according to some embodiments of the present invention, poly(trimethylene terephthalate) may be present in an amount of from about any of the foregoing amounts to about any other of the foregoing amounts.

The polyester resin (B) of the present invention can have an intrinsic viscosity[η] of about 0.9 to about 1.5 dl/g, for example about 0.95 to about 1.1 dl/g, and as another example about 0.98 to about 1.05 dl/g, as measured in an o-chlorophenol solution of 25° C. A value of the carboxylic end group can be about 5 to about 80 meq/kg, for example about 8 to about 50 meq/kg, and as another example about 10 to about 40 meq/kg.

The base resin including the polyester resin (A) having a crystallization temperature of about 200° C. to about 400° C. and the polyester resin (B) having a crystallization temperature of about 100° C. to less than about 200° C. can include the polyester resin (B) in an amount of about 10 to about 90% by weight, based on the total weight (100% by weight) of the base resin. In some embodiments, the base resin can include the polyester resin (B) in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90% by weight. Further, according to some embodiments of the present invention, the polyester resin (B) may be present in an amount of from about any of the foregoing amounts to about any other of the foregoing amounts.

When the amount of the polyester resin (B) is less than about 10% by weight, the impact resistance of the polyester resin composition at high temperatures can be reduced. When the amount of the polyester resin (B) is more than about 90% by weight, crystallization temperatures (Tc) and heat resistance (HDT) of the polyester resin composition can be reduced.

(C) White Pigment

The white pigment is used as an essential component of the present invention in order to obtain sufficient reflectivity. Examples of the white pigment (C) can include without limitation titanium oxide, zinc oxide, zinc sulfide, white lead, zinc sulfate, barium sulfate, calcium carbonate, aluminum oxide, and the like. The white pigment can be used alone or in combination of two or more thereof.

The white pigment can be surface treated with a silane coupling agent and/or a titanium coupling agent. A silane-based compound such as vinyltriethoxy silane, 3-aminopropyltriethoxy silane, and/or 3-glycidoxypropyltriethoxysilane can be used to treat the surface thereof.

In exemplary embodiments, the white pigment includes titanium dioxide (TiO₂). Optical properties such as reflectivity and concealing properties can be improved by using titanium dioxide. The fabrication method of titanium dioxide is not limited, and industrial titanium dioxide can be used. In exemplary embodiments, a rutile type of titanium dioxide can be used. The titanium dioxide can have an average particle diameter of about 0.05 to about 2.0 μm, for example about 0.05 to about 0.7 μm.

The titanium dioxide can be surface treated with an inorganic surface treating agent and/or an organic surface treating agent. Examples of the inorganic surface treating agent can include without limitation aluminum oxide (alumina, Al₂O₃), silicon dioxide (Silica, SiO₂), zirconium dioxide (Zirconia, ZrO₂), sodium silicate, sodium aluminate, sodium silicate aluminate, zinc oxide, mica, and the like, and these can be used alone or a mixture of two or more thereof. Examples of the organic surface treating agent can include without limitation poly(dimethyl siloxane), trimethylpropane (TMP), pentaerythritol, and the like, and these can be used alone or a mixture of two or more thereof.

The surface treating agent can be used in an amount of about 5 parts by weight, or less, based on about 100 parts by weight of titanium dioxide. In exemplary embodiments, titanium dioxide surface treated with about 5 parts by weight, or less, of alumina (Al₂O₃), an inorganic surface treating agent, based on about 100 parts by weight of titanium dioxide can be used.

Titanium dioxide surface treated with alumina can be further modified with an inorganic surface treating agent such as silicon dioxide, zirconium dioxide, sodium silicate, sodium aluminate, sodium silicate aluminate, mica, and the like, and/or an organic surface treating agent such as poly(dimethyl siloxane), trimethylpropane (TMP), pentaerythritol, and the like.

The polyester resin composition can include the white pigment (C) in an amount of about 0.1 to about 80 parts by weight, for example about 5 to about 60 parts by weight, based on about 100 parts by weight of the base resin described herein include the polyester resin (A) and the polyester resin (B). In some embodiments, the polyester resin composition can include the white pigment (C) in an amount of about 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80 parts by weight. Further, according to some embodiments of the present invention, the white pigment (C) may be present in an amount of from about any of the foregoing amounts to about any other of the foregoing amounts.

When the amount of the white pigment is less than about 0.1 parts by weight, the light resistance of the polyester resin composition can be reduced. When the amount of the white pigment is more than about 80 parts by weight, the impact resistance of the polyester resin composition can be reduced.

(D) Filler

In the present invention, fillers having various particle shapes can be further added in the polyester resin composition in order to increase the mechanical properties, heat resistance, and/or dimension stability thereof.

Organic fillers and/or inorganic fillers can be used. Specific examples of filler can include without limitation carbon fiber, glass fiber, boron fiber, glass bead, glass flake, carbon black, clay, kaolin, talc, mica, sodium carbonate, and the like, and combinations thereof. Needle-shaped fillers can be used in order to obtain molded articles having high surface flatness. Examples of the needle-shaped fillers can include without limitation wollastonite, potassium titanate whisker, aluminum borate whisker, zinc oxide whisker, calcium whisker, and the like, and combinations thereof.

Glass fiber, wollastonite, potassium titanate whisker, and/or aluminate borate whisker can be used among the above-listed fillers to provide high whiteness.

In exemplary embodiments, glass fiber can be used. The use of the glass fiber can improve the moldability of the polyester resin composition, and mechanical properties such as tensile strength, bending strength, and bending elasticity, and heat resistance such as thermal deformation temperatures of molded articles fabricated by the polyester resin composition.

The glass fiber can have an average length of about 0.1 to about 20 mm, for example about 0.3 to about 10 mm. The aspect ratio (L/D=an average length of fiber/an average outer diameter of the fiber) of the glass fiber can be about 10 to about 2,000, for example about 30 to about 1,000. When glass fiber having an aspect ratio within the above-mentioned range is used, the impact strength of the polyester resin composition can be remarkably improved. The cross-sectional shape of the glass fiber is not limited, and glass fiber having various cross-sectional shapes, including circular, can be used depending on the specific purposes of the composition.

The polyester resin composition can include the filler (D) in an amount of about 0.1 to about 80 parts by weight based on about 100 parts by weight of the base resin described herein including the polyester resin (A) and the polyester resin (B). In some embodiments, the polyester resin composition can include the filler (D) in an amount of about 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80 parts by weight. Further, according to some embodiments of the present invention, the filler (D) may be present in an amount of from about any of the foregoing amounts to about any other of the foregoing amounts.

(E) Nucleating Agent

A nucleating agent and a chain extender, such as a compound in which an end group of bisphenol-A is substituted with an epoxy group (discussed below) are introduced into the polyester resin in order to maintain the reflectivity and the impact resistance of the polyester resin composition, which is required for the reflector of the light emitting device in the present invention, and to improve cooling efficiency which shortens the molding cycle time of a molding operation.

The inventor has recognized that the combination of above-mentioned components in the polyester resin composition maintains the impact resistance of polyester resin compositions or polyester resin compositions reinforced with glass fiber, thereby preventing cracking phenomenon regardless of the thin film molding of reflectors having on micro-designs; and improves cooling efficiency to enhance the heat resistance of the reflectors.

The nucleating agent (E) can include without limitation disodium terephthalate represented by Chemical Formula 3 below:

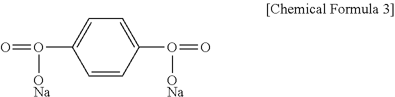

The polyester resin composition can include the nucleating agent (E) in an amount of about 0.01 to about 10 parts by weight, based on about 100 parts by weight of the base resin described herein includes the polyester resin (A) and the polyester resin (B). In some embodiments, the polyester resin composition can include the nucleating agent (E) in an amount of about 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, 9, or 10 parts by weight. Further, according to some embodiments of the present invention, the nucleating agent (E) may be present in an amount of from about any of the foregoing amounts to about any other of the foregoing amounts.

When the amount of the nucleating agent is more than about 10 parts by weight, increased out-gassing in the process of molding the polyester resin composition can occur. When the amount of the nucleating agent is less than about 0.01 parts by weight, the nucleating agent may not function adequately as a nucleating agent for enhancing cooling efficiency.

(F) Chain Extender

As described above, the combination of disodium terephthalate as the nucleating agent (E) and a compound in which an end group of bisphenol-A is substituted with an epoxy group (or an epoxy group-substituted bisphenol-A compound) represented by below Chemical Formula 4 as the chain extender (F) can be used for the present invention. In this case, the impact resistance of the polyester resin composition is maintained, and cooling efficiency thereof can be improved.

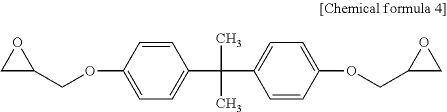 [SMILES: CC(C)(c1ccc(OCC2CO2)cc1)c1ccc(OCC2CO2)cc1]

The epoxy group-substituted bisphenol-A compound, a compound functioning as the chain extender, reacts with —OH and/or —COOH end groups of a polyester resin (A), which is generally molded at a high temperature of 240° C. or more in order to prevent the viscosity of the polyester resin (A) from being reduced due to the decomposition thereof by heat, thereby minimizing reduction in the impact resistance of the polyester resin composition.

The polyester resin composition can include the chain extender (F) in an amount of about 0.01 to about 10 parts by weight, based on about 100 parts by weight of the base resin described herein including the polyester resin (A) and the polyester resin (B). In some embodiments, the polyester resin composition can include the chain extender (F) in an amount of about 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, 9, or 10 parts by weight. Further, according to some embodiments of the present invention, the chain extender (F) may be present in an amount of from about any of the foregoing amounts to about any other of the foregoing amounts.

When the chain extender is present in an amount more than about 10 parts by weight, the moldability of the polyester resin composition can be reduced due to excessive increase in the viscosity thereof. When the chain extender is present in an amount less than about 0.01 parts by weight, the polyester resin composition may not exhibit improved the impact resistance.

The polyester resin composition can include the nucleating agent (E) and the chain extender (F) at the same time, and the weight ratio of the nucleating agent (E) and the chain extender (F) can be about 1:10 to about 10:1.

(G) Other Additives

The polyester resin composition of the present invention can further comprise one or more other additives in addition to the above-mentioned components. Examples of the additives can include without limitation UV stabilizers, fluorescent brightening agents, lubricants, release agents, antistatic agents, stabilizers, reinforcing materials, inorganic additives, coloring agents such as pigments and/or dyes, and the like, and combinations thereof.

The UV stabilizer suppresses changes in the color of resin compositions and reduction in photo reflectivity due to the irradiation of UV rays. Examples of the UV stabilizer can include without limitation benzotriazole-based UV stabilizers, benzophenone-based UV stabilizers, triazine-based UV stabilizers, salicylate-based UV stabilizers and the like, and combinations thereof.

The fluorescent brightening agent improves the photo reflectivity of the polyester resin composition. Examples of the fluorescent brightening agent can include without limitation stilbene-bisbenzooxazole derivatives such as 4-(benzooxazole-2-yl)-4′-(5-methylbenzooxazole-2-yl)stilbene and/or 4,4′-bis(benzooxazole-2-yl)stilbene.

Examples of the release agent can include without limitation fluorine-containing polymers, silicone oils, metal salts of stearic acid, metal salts of montanic acid, montanic acid ester waxes, polyethylene waxes, and the like, and combinations thereof.

The polyester resin composition of the present invention can be used as materials for molded articles which require superior heat resistance, impact resistance, reflectivity, yellowing resistance, and/or fluidity. Particularly, the polyester resin composition of the present invention comprises an adequate amount of a white pigment, so that it can have superior reflectivity and impact strength. Also, the reflectivity reduction and the yellowing reduction thereof can be low, and sufficient cooling efficiency thereof can be obtained regardless of having been left for a long period of time under a constant temperature/humidity condition. Thus, the polyester resin composition of the present invention can be used as a material for the manufacture of reflectors for various kinds of light emitting devices, including LEDs which are constantly exposed to high temperature environment.

A molded article fabricated by the polyester resin composition of the present invention can have about 90% or more initial reflectivity, as measured at a wavelength of 440 nm using a color-difference meter; less than about 10% reflectivity reduction, as measured at a wavelength of 440 nm before and after being left for 192 hours at a temperature of 85° C. and a relative humidity of 85%; and a yellow index change of about 5 or less (ΔYI), as measured before and after being left for 192 hours at a temperature of 85° C. and a relative humidity of 85%.

Also, the molded article can have a result value of about 3.7 N/cm² or more, as measured by a push test, which is a method for evaluating impact resistance (Cheil method-1) which is conceived by the present inventor to prevent molded articles from cracking during a molding operation; and a cooling time of about 20 or less seconds as measured by a cooling time evaluation method (Cheil method-2) which is conceived to evaluate the cooling efficiency of a molded article molding operation.

The polyester resin composition of the present invention can be applicable for reflectors for LEDs and further any products which reflect rays. For example, it can be used in reflectors for light emitting devices such as various electronic parts, indoor lamps, outdoor lamps, vehicle lamps, display devices, and head lights.

The present invention will be described with reference to the following examples, which are intended for the purpose of illustration only and are not to be construed as in any way limiting the scope of the present invention.

### Examples

The specifications for each component used in the examples and comparative examples are as follows.

(A) Polyester Resin Having a Crystallization Temperature of about 200° C. to about 400° C.

A poly(cyclohexane-1,4-dimethylene terephthalate) (PCT) resin is used, prepared by the condensation polymerization of terephthalic acid and 1,4-cyclohexane dimethanol, and having an intrinsic viscosity[η] of 0.6 dl/g, a melting point of 290° C., and a crystallization temperature of 241° C.

(A′) Polyamide (PA6T) Resin

As a comparative example, PA6T, a semi-aromatic polyamide resin having a benzene ring in its main chain, is used, prepared by the condensation polymerization of terephthalic acid and hexamethylene diamine, and having an intrinsic viscosity[η] of 0.7 dl/g, a melting point of 320° C., and a crystallization temperature of 295° C.

(B) Polyester Resin Having a Crystallization Temperature of about 100° C. to Less than about 200° C.

A poly(trimethylene terephthalate) (PTT) resin is used, prepared by the condensation polymerization of terephthalic acid and 1,3-propanediol, and having an intrinsic viscosity[η] of 1.0 dl/g, a melting point of 215° C., and a crystallization temperature of 165° C.

(C) White Pigment

Titanium dioxide having a particle diameter of 0.25 μm manufactured by Kronos 2233 of Kronos Corporation is used.

(D) Filler Glass fiber 910 having an aspect ratio of 230 manufactured by Owens Corning Corporation is used.

(E) Nucleating Agent

Disodium terephthalate manufactured by DSM Corporation is used.

(F) Chain extender

PKHH, a phenoxy resin manufactured by Inchem Corporation, is used.

### Examples 1 to 3 and Comparative Examples 1 to 5

Each component is added in the amount set forth in Table 1 and melted/kneaded in a biaxial melting extruder heated to 240 to 350° C. to make pellets. Pellets obtained thereby are dried at a temperature of 120° C. for 5 or more hours, and then a specimen for evaluating material properties is fabricated using a screw-type injection unit heated to 240 to 330° C.

As shown in Table 1, the amounts of each component is represented as parts by weight based on 100 parts by weight of (A) and (B)

TABLE 1

| | Examples | | | Comparative examples | | | | |
|---|---|---|---|---|---|---|---|---|
| Components | 1 | 2 | 3 | 1 | 2 | 3 | 4 | 5 |
| (A) PCT resin | 50 | 70 | 50 | 50 | 100 | — | 50 | — |
| (A′) PA6T resin | — | — | — | 50 | — | 50 | 50 | — |
| (B) PTT resin | 50 | 30 | 50 | — | — | 50 | — | 100 |
| (C) White | 15 | 40 | 40 | 50 | 100 | 40 | 40 | 30 |
| pigment | | | | | | | | |
| (D) Filler | 20 | 15 | 20 | 20 | 20 | 20 | 20 | 20 |
| (E) Nucleating | 0.5 | 0.5 | 1 | 0.5 | — | 3 | 1 | 3 |
| agent | | | | | | | | |
| (F) Chain | 1 | 3 | 0.5 | — | 1 | 2 | 3 | 0.5 |
| extender | | | | | | | | |

(Unit: Parts by weight)

Properties of the specimens obtained based on the components of the above table 1 are evaluated, and the results are set forth in Table 2.

Evaluation Methods for Material Properties

(1) Heat resistance (HDT): Heat resistance is evaluated by measuring a heat deformation temperature (HDT) of a specimen with a thickness of ¼ inch under 1.82 MPa load in accordance with ASTM D648.

(2) Reflection properties (Reflectivity): Initial reflectivity (SCI, specular component included) at a wavelength of 440 nm is measured using a 3600D CIE Lab. color-difference meter of Konica Minolta Corporation; reflectivity is re-measured after the specimen is left for 192 hours at a temperature of 85° C. and a relative humidity of 85%; and reduction in reflectivity is evaluated.

(3) Yellowing resistance (Yellow index): An initial yellow index (YI) is measured using a 3600D CIE Lab. color-difference meter of Konica Minolta Corporation; a yellow index is re-measured after the specimen is left for 192 hours at a temperature of 85° C. and a relative humidity of 85%; and change in the yellow index is evaluated.

(4) Impact resistance (Push test): A push test is performed as an index for relatively evaluating the practical impact strength of molded articles. A reflector molded article using a resin composition is loaded on a holder, and a breaking strength of the molded article is measured with a pressure rod having a diameter of 5 mm (Cheil method-1) at the time when the center part of the molded article is pressed and the molded article is destroyed. The method of the push test is roughly shown as below.

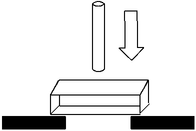

(5) Impact resistance (Izod impact strength): A specimen with a thickness of ⅛ inch is measured in an unnotched state in accordance with ASTM D256. Impact strength of each fabricated specimen is evaluated by differentiating set injection molding temperatures thereof at 300° C. and at 330° C. The reduction ratio of the impact resistance of the specimen fabricated by setting the injection molding temperature at 330° C. is calculated compared to the impact resistance of the specimen fabricated by setting the injection molding temperature at 300° C.

(6) Fluidity (Melt flow index, MI): An MI is measured under a temperature of 300° C. and a load of 1.2 Kg in accordance with ASTM D1238.

(7) Cooling efficiency (Cooling time): It is an index for relatively evaluation cooling efficiency. When a resin composition is injection molded at an injection temperature of 300° C. using a specific mold with 48 LED reflector-shaped cavities and a 750 Ton injection machine, the minimum cooling time required for completely molding the resin composition after filling the mold with the molten resin composition is measured (Cheil method-2).

TABLE 2

| | | Examples | | | Comparative examples | | | | |
|---|---|---|---|---|---|---|---|---|---|
| | | 1 | 2 | 3 | 1 | 2 | 3 | 4 | 5 |
| HDT (° C.) | | 225 | 235 | 221 | 248 | 253 | 240 | 248 | 170 |
| Reflectivity | Before constant | 92.2 | 92.5 | 92.4 | 92.3 | 92.1 | 92.4 | 92.7 | 91.4 |
| (%) | temperature/ | | | | | | | | |
| | constant humidity | | | | | | | | |
| | After constant | 84.5 | 86.2 | 85.1 | 56.3 | 82.4 | 51.7 | 47.4 | 67.5 |
| | temperature/ | | | | | | | | |
| | constant humidity | | | | | | | | |
| | Reflectivity | 7.7 | 6.3 | 7.3 | 36 | 9.7 | 40.7 | 45.3 | 23.9 |
| | difference | | | | | | | | |
| Yellow | Before constant | 3.8 | 3.9 | 4.0 | 5.1 | 3.8 | 4.9 | 5.2 | 4.2 |
| index | temperature/ | | | | | | | | |
| | constant humidity | | | | | | | | |
| | After constant | 8.8 | 8.9 | 8.2 | 30.8 | 19.4 | 31.7 | 36.5 | 25.4 |
| | temperature/ | | | | | | | | |
| | constant humidity | | | | | | | | |
| | Difference in | 5.0 | 5.0 | 4.2 | 25.7 | 15.6 | 26.8 | 31.3 | 21.2 |
| | yellow indexes | | | | | | | | |
| Push test (N/cm²) | | 3.8 | 3.7 | 4.0 | 1.2 | 1.4 | 3.9 | 2.1 | 4.0 |
| Izod impact | 300° C. injection | 18.4 | 17.9 | 18.2 | 7.8 | 10.4 | 6.8 | 9.4 | 19.8 |
| strength | 330° C. injection | 14.5 | 15.1 | 14.7 | 4.1 | 2.7 | 2.4 | 3.1 | 3.8 |
| (kgf · cm/cm) | Reduction ratio | 21.2 | 15.6 | 19.2 | 47.4 | 74.0 | 64.7 | 67.0 | 80.8 |
| | (%) | | | | | | | | |

| | | | | | | | | |
|---|---|---|---|---|---|---|---|---|
| MI (g/10 min) | 31 | 32 | 30 | 2 | 60 | 3 | N/F | 16 |
| Cooling time (sec) | 12 | 13 | 12 | 28 | 31 | 12 | 29 | 38 |

(Reference) N/F: no flow, not measurable

As shown in Table 2, the polyester resin compositions of Examples 1 to 3 according to the present invention exhibit superior reflectivity, yellowing resistance, and fluidity without reducing heat resistance and impact resistance. Rapid cooling time thereof improves cooling efficiency, and impact resistance retention rate thereof is kept high even under injection conditions at high temperatures.

On the other hand, Comparative Example 5 using only polyester resin (B) exhibits a high push test result, but Izod impact strength thereof is remarkably reduced under the injection condition at high temperatures. Heat resistance thereof is also reduced. Also, it is recognized that both Comparative Examples 3 and 4 which use a mixture of the polyester resin (A) and the polyamide resin (A′) or a mixture of the polyester resin (B) and the polyamide resin (A′) obtain high heat resistance, but reflectivity and yellowing resistance retention characteristic thereof are reduced.

In Comparative Example 2, an excessive amount of the white pigment (C), outside of the range of the present invention, results in a low push test result and Izod impact strength, and the cooling efficiency is reduced since the nucleating agent (E) is not used.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A polyester resin composition comprising:
(A) a polyester resin having a crystallization temperature of about 200° C. to about 400° C.;
(B) a polyester resin having a crystallization temperature of about 100° C. to less than about 200° C., wherein the polyester resin (B) is not the same as polyester resin (A) and has a different crystallization temperature than polyester resin (A);
(C) a white pigment;
(D) a filler;
(E) a nucleating agent; and
(F) a chain extender.

2. The polyester resin composition of claim 1, comprising:
about 0.1 to about 80 parts by weight of the white pigment (C);
about 0.1 to about 80 parts by weight of the filler (D);
about 0.01 to about 10 parts by weight of the nucleating agent (E); and
about 0.01 to about 10 parts by weight of the chain extender (F), each based on about 100 parts by weight of a base resin comprising about 10 to about 90% by weight of the polyester resin (A) having a crystallization temperature of about 200° C. to about 400° C. and about 10 to about 90% by weight of the polyester resin (B) having a crystallization temperature of about 100° C. to less than about 200° C.

3. The polyester resin composition of claim 1, wherein the polyester resin (A) is prepared by condensation polymerization of an aromatic dicarboxylic acid component and a diol component including an alicyclic diol.

4. The polyester resin composition of claim 1, wherein the polyester resin (A) includes a poly(cyclohexane-1,4-dimethylene terephthalate) (PCT)-based resin including a repeating unit represented by Chemical Formula 1: 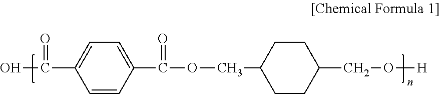
wherein n is an integer of 50 to 500.

5. The polyester resin composition of claim 1, wherein the polyester resin (B) includes a poly(trimethylene terephthalate) (PTT)-based resin including a repeating unit represented by Chemical Formula 2. 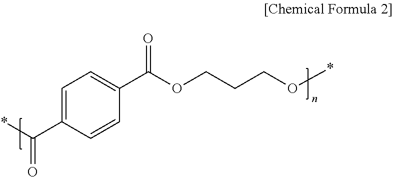
wherein n is an integer of 50 to 500.

6. The polyester resin composition of claim 1, wherein the polyester resin (A) comprises about 15 to about 100 mole % of 1,4-cyclohexane dimethanol and 0 to about 85 mole % of ethylene glycol based on 100 mole % of the diol component.

7. The polyester resin composition of claim 5, wherein the polyester resin (B) further comprises a homopolymer and/or a copolymer of alkylene terephthalate which has a different structure from the repeating unit structure of Chemical Formula 2.

8. The polyester resin composition of claim 7, wherein the homopolymer and/or the copolymer of the alkylene terephthalate is a homopolymer and/or a copolymer of a C₂ to C₈ alkylene terephthalate which has a different structure from the repeating unit structure of Chemical Formula 2.

9. The polyester resin composition of claim 7, wherein the homopolymer and/or the copolymer of alkylene terephthalate includes a homopolymer and/or a copolymer of butylene terephthalate, a homopolymer and/or a copolymer of ethylene terephthalate, and/or a homopolymer and/or a copolymer of hexamethylene terephthalate.

10. The polyester resin composition of claim 1, wherein the white pigment (C) comprises titanium oxide, zinc oxide, zinc sulfide, white lead, zinc sulfate, barium sulfate, calcium carbonate, aluminum oxide, or a combination thereof.

11. The polyester resin composition of claim 1, wherein the white pigment (C) is titanium dioxide having an average particle diameter of about 0.05 to about 2.0 μm.

12. The polyester resin composition of claim 1, wherein the filler (D) comprises carbon fiber, glass fiber, boron fiber, glass bead, glass flake, carbon black, clay, kaolin, talc, mika, calcium carbonate, wollastonite, potassium titanate whisker, aluminum borate whisker, zinc oxide whisker, calcium whisker, or a combination thereof.

13. The polyester resin composition of claim 12, wherein the filler (D) includes glass fiber having an average length of about 0.1 to about 20 mm and an aspect ratio of about 10 to about 2,000.

14. The polyester resin composition of claim 1, wherein the nucleating agent (E) includes disodium phthalate represented by Chemical Formula 3.

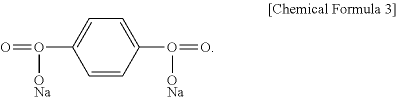

15. The polyester resin composition of claim 1, wherein the chain extender (F) includes a compound including an end group of bisphenol-A, wherein the end group of bisphenol-A is substituted by an epoxy group, and wherein the bisphenol-A is represented by Chemical Formula 4:

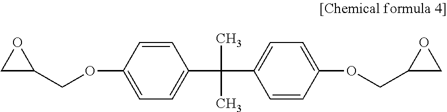 [SMILES: CC(C)(c1ccc(OCC2CO2)cc1)c1ccc(OCC2CO2)cc1]

16. The polyester resin composition of claim 1, comprising the nucleating agent (E) and the chain extender (F) in a weight ratio of about 1:10 to about 10:1.

17. A molded article prepared by the polyester resin composition of claim 1.

18. The molded article of claim 17, wherein the molded article is a reflector of a light emitting device.
